(19) United States
(12) Patent Application Publication
(10) Pub. No.: US 2026/0264286 A1
(43) Pub. Date: Sep. 10, 2026

(54) PLANT FIBER MAT BASED ON WOOD FIBERS

(71) Applicant: SAINT-GOBAIN ISOVER, COURBEVOIE (FR)

(72) Inventors: Blaise DUPRE, COURBEVOIE (FR); Quentin RIAMON, COURBEVOIE (FR); Arnaud SOISSON, COURBEVOIE (FR)

(21) Appl. No.: 19/166,290

(22) PCT Filed: Mar. 12, 2024
(86) PCT No.: PCT/FR2024/050297

§ 371 Date: Sep. 17, 2025

(30) Foreign Application Priority Data
Mar. 17, 2023 (FR) FR2302519

(51) Int. Cl. B27N 3/12; B27N 3/00; B27N 3/04

(52) U.S. Cl. CPC B27N 3/12; B27N 3/002; B27N 3/04

(57) ABSTRACT

A plant fiber mat includes wood fibers which are derived from woody plants and are secured to one another by heat-bonding fibers, the heat-bonding fibers having a decitex of less than or equal to 1.7 dtex.

The present invention relates to the field of building materials, and more particularly building materials intended to ensure thermal and/or acoustic insulation.

Building materials represent a major proportion of energy consumption and greenhouse gas emissions. Among these building materials, mineral wools are the materials intended for insulation that consume energy the most. The manufacturers of building materials intended for insulation are looking to reduce the environmental impact of insulation materials.

In particular, insulating mats formed of plant fibers comprising wood fibers are known. The forests in which it is possible to source wood for making these insulating mats have the advantage of being scattered throughout the territory, so that this allows installing the defibration and insulating mat manufacturing plants the closest to the forests in order to fit in a circular economy context.

Moreover, it is known to bond these plant fibers with heat-bonding fibers, which ensure holding of the fibers relative to one another once all these fibers have passed through an oven, but the use of these heat-bonding fibers, comprising plastic materials, should be controlled in order to ensure that the produced panels of insulating materials are the most bio-sourced products as possible.

The present invention takes account of these concepts of circular economy and bio-sourced products, by aiming to propose in this dual context an insulating product that has low thermal conductivity values.

The present invention relates to a plant fiber mat characterized in that it comprises wood fibers derived from woody plants and secured to one another by means of heat-bonding fibers, the heat-bonding fibers having a decitex lower than or equal to 1.7 dtex.

At least part of the plant fibers present in the mat according to the invention, i.e. a mat intended for making insulating panels, and in particular semi-rigid panels intended for the interior insulation of buildings, is formed by a set of wood fibers derived from woody plants. In contrast to an herbaceous plant, a woody plant is a plant that contains a high level of lignins, which are organic macromolecules conferring solidity on the plant. In particular, the wood fibers derived from the wood of such woody plants may be produced by silviculture.

As mentioned before, wood is a widely available and mobilizable resource as it is produced throughout the metropolitan French but also European territory. Therefore, making insulating panels using wood fibers derived from woody plants perfectly fits in a circular economy approach since it is possible to implant defibration and insulating panel manufacturing plants in sparse areas of the territory the closest to potential buyers.

The wood fibers of the plant fiber mat according to the invention may be obtained from different woody plants such as, for example, Douglas fir, common beech, poplar, willow or spruce.

The wood fibers are secured to one another by means of heat-bonding fibers. These heat-bonding fibers have a rigid core and a more flexible sheath. The core and the sheath have distinct melting temperatures. More specifically, the core has a melting temperature higher than the melting temperature of the sheath. The mixture of heat-bonding fibers and plant fibers is intended to be heated in an oven at a temperature such that the sheath melts down and bonds with the adjacent plant fibers in contact with the sheath whereas the structure of the core is not altered. It should be understood that the heat-bonding fibers ensure, on the one hand, securing the plant fibers to one another by means of the sheath and, on the other hand, a mechanical role by conferring mechanical strength on the plant fiber mat by means of the rigid core. These heat-bonding fibers are mixed with the plant fibers in a percentage that is sufficient to achieve suitable adhesion of the plant fibers with one another but low enough to not limit the insulating properties of the plant fiber mat.

The decitex of the heat-bonding fibers is a known parameter which defines the fineness of said heat-bonding fibers. It should be noted that this parameter defines the fineness of the heat-bonding fibers before passage thereof in an oven and partial melting thereof. Thus, the decitex of the heat-bonding fibers should be measured before mixing the plant fibers and the heat-bonding fibers, or at least before passage of the mixture in the oven.

More specifically, the Inventors have demonstrated that, in a context where it is desired to use as much bio-sourced elements as possible, the heat-bonding fibers with a low decitex allows reducing the mass of heat-bonding fibers relative to the mass of the plant fiber mat, yet without limiting the hold of the plant fibers relative to one another thanks to these heat-bonding fibers and therefore ensuring that thermal bridges are not created between the plant fibers and do not degrade the thermal insulation properties.

This reduction of the mass of heat-bonding fibers is possible through a better homogenization of the mixture of plant fibers and heat-bonding fibers. Indeed, for the same fiber length, heat-bonding fibers having a low decitex are finer than heat-bonding fibers having a higher decitex. Therefore, the heat-bonding fibers mixed with the wood fibers fit better between neighboring wood fibers and therefore spread better throughout the volume of the plant fiber mat. In this context, for the same thermal performances, it is possible to reduce the percentage of required heat-bonding fibers and to improve the bio-sourced component content within the end product.

Through adequate tests, the Inventors have been able to determine that mixing wood fibers derived from woody plants and heat-bonding fibers with a decitex lower than usual, and in particular lower than 1.7, allows making a mat with a high bio-sourced product content and particularly suitable for building insulation, and in particular for the interior insulation of these buildings. In particular, the plant fiber mat in accordance with the invention has a thermal conductivity lower than 37 mW/m/K at 10° C.

According to a feature of the invention, the heat-bonding fibers have a decitex lower than or equal to 1.5 dtex. Based on this value, the methods to be implemented to obtain such fine heat-bonding fibers are complex, but the Inventors have been able to note that the thermal conductivity of an insulating material using such fine heat-bonding fibers is reduced and could tend towards thermal conductivity values lower than or equal to 37 mW/m/K at 10° C.

According to a feature of the invention, the wood fibers are derived from resinous woody plants. In particular, the wood fibers may be derived from Douglas fir or spruce.

According to a feature of the invention, the plant fiber mat comprises at least 50% of wood fibers derived from woody plants.

According to a feature of the invention, the plant fiber mat comprises adjuvant fibers derived from agriculture. These adjuvant fibers may comprise a lignin content significantly lower than the lignin content of the wood fibers, in particular to confer more flexibility on the plant fiber mat made of the wood fibers and the adjuvant fibers. As examples, these adjuvant fibers may consist of hemp or flax fibers.

According to a feature of the invention, the plant fiber mat comprises at least 80% of wood fibers and at most 20% of adjuvant fibers.

According to a feature of the invention, the plant fiber mat comprises at most 10% of heat-bonding fibers. It should be understood herein and later on that the percentage of heat-bonding fibers is a mass percentage, i.e. representative of the mass of the heat-bonding fibers relative to the mass of the considered plant fiber mat.

According to a feature of the invention, the plant fiber mat comprises between 2% and 5% of heat-bonding fibers.

According to a feature of the invention, the plant fiber mat comprises at least 95% of fibers and at most 5% of additives. The additives comprise at least additives characterized by their flame-retardant properties. The fibers comprise both wood fibers and heat-bonding fibers. According to a feature of the invention, in this ratio of at least 95% of fibers, at least 95% of the fibers are wood fibers. As example, for a plant fiber mat comprising 4% of additives and therefore 96% of fibers, the plant fiber mat comprises about 92% of wood fibers, about 4% of heat-bonding fibers and 4% of additives. According to another non-limiting example of this feature, for a plant fiber mat comprising 3% of additives and therefore 97% of fibers, the plant fiber mat comprises about 93% of wood fibers, about 4% of heat-bonding fibers and 3% of additives.

According to a feature of the invention, the wood fibers derived from woody plants have a cellulose content comprised between 30 and 60 kg·100 kg⁻¹ of dry matter and a lignin content comprised between 18 and 30 kg·100 kg⁻¹ of dry matter.

The lignin and cellulose content of these wood fibers is measured from dry matter. The dry matter that is considered herein is obtained by drying in a ventilated oven products derived from woody plants, for example wood residues, from which the plant fibers are obtained. In this ventilated oven, the products derived from woody plants are heated to about 105° C. until obtaining a constant mass in the oven. This constant mass is commonly referred to as the reference mass and the cellulose, lignin and other components contents are expressed based on this reference mass. It should be noted that the oven considered herein is an oven distinct from the oven allowing heating the mixture of heat-bonding fibers and wood fibers within the mat.

Through adequate tests, the Inventors have been able to notice that wood fibers that have lignin contents and cellulose contents as mentioned are particularly suitable for use thereof within plant fiber mats for insulation products. As mentioned before, the plant fiber mat according to the invention can be obtained from different woody plants such as, for example, Douglas fir, common beech, poplar, willow or spruce.

According to a feature of the invention, the wood fibers derived from woody plants have a cellulose content comprised between 41.2 and 56.4 kg·100 kg⁻¹ of dry matter and a lignin content comprised between 23.7 and 28.1 kg·100 kg⁻¹ of dry matter. The Inventors have been able to demonstrate that the plant fibers originating more particularly from Douglas fir have structural characteristics that are more interesting for obtaining a plant fiber mat in accordance with the invention whose thermal conductivity is low.

According to a feature of the invention, the plant fiber mat is formed of a mixture of wood fibers with at least two types of wood fibers derived from different woody plants, provided that at least 50% of the fibers present in the plant fiber mat are wood fibers derived from woody plants.

According to a feature of the invention, at least 70% of the wood fibers have a diameter smaller than or equal to 100 μm.

According to a feature of the invention, at least 60% of the wood fibers have a diameter smaller than 70 μm.

According to a feature of the invention, at least 45% of the wood fibers have a diameter smaller than 50 μm.

In each of these three features, the aim is to reduce the amount of wood fibers whose diameter is deemed to be too large. Thus, the aim is to avoid as much as possible the presence, in the plant fiber mat, of wood fibers whose excessively large diameter penalizes the overall insulation performance of the mat.

In this respect, there is a difference from features according to which the diameter of the fibers within the mat is to be defined by a desired average value, or maximum average value, this average value not preventing a great diversity of the diameter values of the fibers around this average value.

According to a feature of the invention, at least 60% of the wood fibers have a diameter comprised between 30 μm and 70 μm. In accordance with the foregoing, a plant fiber mat comprising such a distribution of wood fibers has high insulation performances, insofar as the dispersion of the diameter of the wood fibers is controlled. One objective herein is a distribution of wood fibers whose diameter is centered around a target value, with few wood fibers having a diameter below a low threshold, herein 30 μm, to avoid part of the wood fibers being in a powder form, in particular because of a production process where an excessive baking and an excessive pressure of fiberizing disks are applied, and, at the same time, with few wood fibers having a diameter above a high threshold, herein 70 μm, for the aforementioned reasons.

The Inventors have been able to notice that the thermal conductivity value of a plant fiber mat according to the invention was even lower, and therefore interesting for application in building insulation, when the particle size distribution of the wood fibers present in the mat was in accordance with some values. In particular, to obtain the desired thermal conductivity values, at least lower than 0.037 W/m/K, one objective is to have at least 60% of the wood fibers having a diameter smaller than or equal to 70 microns. The large amount of fine wood fibers that results from this particle size distribution allows for a good thermal conductivity of the end product, in particular because of the average fineness of the wood fiber and because of the homogeneity of fineness between the wood fibers and the heat-bonding fibers.

Having homogeneity between the fineness of the heat-bonding fibers, i.e. heat-bonding fibers with a low decitex, and the fineness of the wood fibers allows for a good mixture of all fibers, it being understood that a non-homogeneous distribution promotes the formation of local clusters of heat-bonding fibers which implies an absence of these heat-bonding fibers in other areas of the mat and therefore wood fibers likely to come into contact with one another and create a thermal bridge which is detrimental to the thermal conductivity value of the end product.

The particle size distribution as claimed, i.e. the fact that at least a given percentage of wood fibers has a diameter below a threshold value and the fact that at least 60% of the wood fibers have a diameter comprised between 30 μm and 70 μm, can be ensured in particular through an appropriate setting of baking of the fibers and an appropriate setting of the pressure of the fiberizing disks used after baking to impart the appropriate shape thereto.

It should be noted that the feature relating to the diameter of the wood fibers is specifically considered but it is possible to combine these features with other features relating to the dimension of the wood fibers, like their length.

According to a feature of the invention, at least 85% of the wood fibers have a length smaller than or equal to 5,000 μm.

According to a feature of the invention, at least 40% of the wood fibers have a length smaller than 2,000 μm.

According to a feature of the invention, the plant fiber mat has a thickness larger than 20 mm.

According to a feature of the invention, the plant fiber mat has a thickness of at least 40 mm.

The thickness of the plant fiber mat to be considered herein is the nominal thickness of the mat, i.e. the thickness that can be measured by the user when using the product, in particular in building insulation.

In accordance with practices that are known from the prior art, the plant fiber mat according to the invention is obtained by the passage through an oven, configured at a determined baking temperature, of a plant fiber carpet made up beforehand, where appropriate on a conveyor device directing the plant fiber carpet to an oven, by a mixture of wood fibers entangled with one another and bonding elements intended to bond the wood fibers to one another upon passage through the oven.

In particular, the nominal thickness may be measured after packaging, for example when purchasing the product. As example, the nominal thickness as mentioned hereinabove is reported after different successive steps of the industrial manufacturing process during the implementation of the product, these steps could comprise, after passage of the wood fiber carpet through the oven, cutting, for example, into panels of suitable dimensions, subsequent compression of the plant fiber mat obtained after passage through the oven during packing, packing, and storage before putting on the market.

According to a feature of the invention, the plant fiber mat has a volumetric density comprised between 20 kg·m³ and 80 kg·m³. More particularly, the plant fiber mat has a volumetric density comprised between 40 kg·m³ and 60 kg·m⁻³.

According to a feature of the invention, the heat-bonding fibers have a length smaller than or equal to 6 mm.

According to a feature of the invention, the heat-bonding fibers comprise at least polyethylene.

According to a feature of the invention, the plant fiber mat has a thermal conductivity lower than or equal to 37 mW/m/K at 10° C. Thus, assembled into panels intended to ensure insulation, in particular in buildings, straw has an interesting thermal conductivity making it a building material intended for insulation.

Other features, details and advantages of the invention will appear more clearly upon reading the following description, on the one hand, and from embodiments of the invention given for indicative and non-limiting purposes with reference to the appended schematic drawings, on the other hand, wherein:

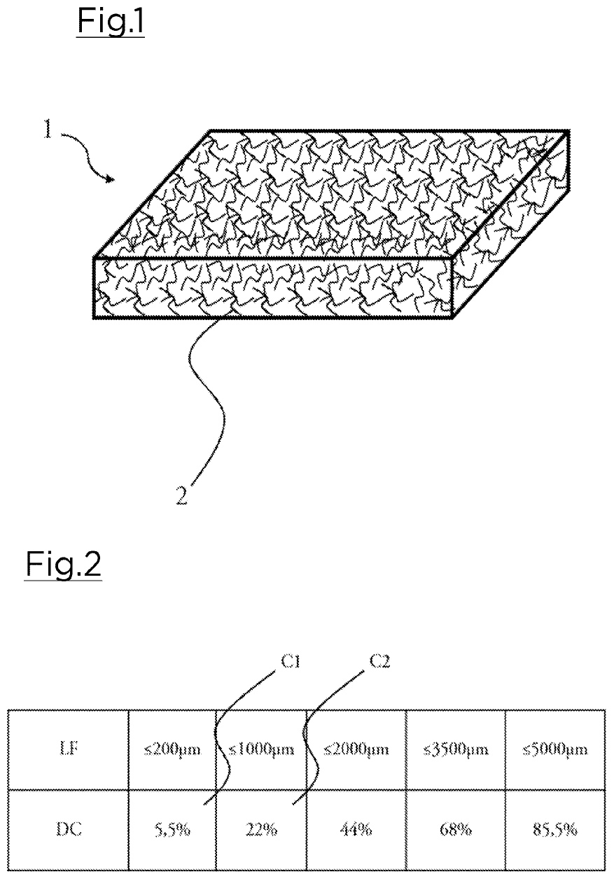

FIG. 1 schematically shows a general view of a plant fiber mat in accordance with the present invention;

FIG. 2 shows a table illustrating a distribution of the wood fibers in the plant fiber mat as a function of their length;

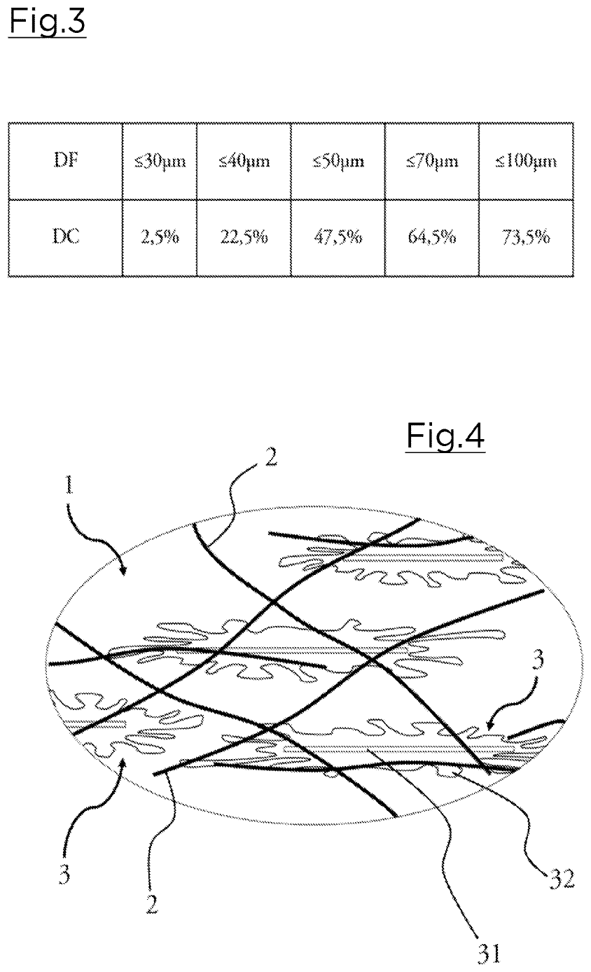

FIG. 3 shows a table illustrating the distribution of the wood fibers in the plant fiber mat as a function of their diameter;

FIG. 4 shows a local view of the wood fibers and of the heat-bonding fibers present within the plant fiber mat shown in FIG. 1.

It should first be noted that while the figures disclose the invention in detail for implementation thereof, these figures could of course be used to better define the invention, where appropriate. It should also be noted that these figures disclose only some embodiments of the invention.

The features, the variants and the different embodiments of the invention may be associated with each other, according to various combinations, insofar as they are not incompatible or mutually exclusive. In particular, one could imagine variants of the invention comprising only a selection of features described hereafter isolated from the other described features, if this selection of features is sufficient to confer a technical advantage or to differentiate the invention from the prior art.

In the figures, elements that are common to several figures keep the same reference.

FIG. 1 shows a plant fiber mat 1 in accordance with the present invention. The plant fiber mat 1 is formed of a plurality of plant fibers entangled with each other and heat-bonding fibers allowing holding the plant fibers in the end product. According to the invention, these plant fibers are wood fibers 2 derived from woody plants, for example produced by silviculture.

The wood fibers 2 used for manufacturing the plant fiber mat 1 are obtained after passage through a defibration unit. As example, these wood fibers may be obtained from residues of the sylvicultural industry or from untreated scrap wood.

This wood may be derived from leafy woody plants, for example, poplar (populus sp.), common beech (fagus sylvatica L.), or willow (salix sp.), or from resinous woody plants such as Douglas fir (pseudotsuga sp.) or spruce (picea sp.). In the shown embodiment, and in the numerical examples that will be given next in the description, the wood fibers are derived from resinous woody plants, and more particularly from Douglas fir scrap wood.

Like other wood of interest such as spruce or common beech, the Douglas fir has a cellulose content comprised between 30 and 60 kg per 100 kg of dry matter, commonly denoted “kg·100 kg⁻¹ DM”, and a lignin content comprised between 18 and 30 kg·100 kg⁻¹ DM. Through adequate tests, the Inventors have been able to find that the wood fibers derived from these woody plants of interest have a structure allowing obtaining, in combination with the presence of heat-bonding fibers, and more particularly heat-bonding fibers of a given thickness, plant fiber mats 1 whose insulating properties are optimum.

More specifically, the Inventors have been able to determine that wood that has structural characteristics close to the Douglas fir was ideal for providing wood fibers capable of forming a plant fiber mat 1 whose insulating properties are optimum. This wood has a cellulose content comprised between 41.2 and 56.4 kg·100 kg⁻¹ DM and a lignin content comprised between 23.7 and 28.1 kg·100 kg⁻¹ DM.

It should be noted that, according to the invention, the plant fiber mat 1 is formed of at least 50% of wood fibers 2 derived from woody plants as mentioned before. Furthermore, the plant fiber mat 1 may comprise adjuvant fibers, not shown herein. These adjuvant fibers may be fibers derived from agriculture such as hemp fibers (Cannabis sativa L.), kenaf fibers (Hibiscus cannabinus L.) or flax fibers (Linum usitatissimum).

In particular, these adjuvant fibers are characterized in that they have a larger length and a lower lignin content than the plant fibers 2 derived from silviculture in accordance with the present invention. This lower lignin content of the adjuvant fibers compared to the plant fibers allows conferring a greater flexibility on the plant fiber mat 1 in comparison with a plant fiber mat devoid of adjuvant fibers.

More particularly, considering only the distribution of the wood fibers within the plant fiber mat, i.e. without taking into account the heat-bonding fibers, it is possible to have between 70% and 90%, preferably 80%, of wood fibers and between 10% and 30%, preferably 20%, of more flexible fibers, like flax or hemp, forming an adjuvant. This ratio allows conferring on the plant fiber mat, on the one hand, flexibility thanks to the low lignin content of the fibers used as an adjuvant and, on the other hand, a good thermal conductivity thanks to the interaction between the heat-bonding fibers and the wood fibers, and in particular a thermal conductivity lower than or equal to 37 mW/m/K at 10° C.

As an illustrative and non-limiting example of the invention, the plant fiber mat 1 comprises 80% of Douglas fir wood fibers and 20% of hemp fibers.

The fiberizing unit is a device allowing forming wood fibers 2 from wood residues obtained, for example, in the form of untreated scrap wood in sawmills. As illustrated in FIGS. 2 and 3, the fiberizing unit is advantageously configured to obtain wood fibers whose median diameter is about 55 μm and the median length of the wood fibers is about 2,500 m.

FIGS. 2 and 3 illustrate the distribution of the wood fibers derived from Douglas fir within a plant fiber mat 1 in accordance with the invention, for a sample with given dimensions, and for which it has been attested that it ensures a thermal conductivity lower than 37 mW/m/K.

More specifically, FIG. 2 illustrates the cumulative distribution CD of the wood fibers as a function of their length LF.

Each cumulative distribution value CD illustrates the percentage of wood fibers, within a given sample, that have a length smaller than a given dimension. As example, FIG. 2 illustrates, in a first box C1, that 5.5% of the wood fibers present in a given sample of a plant fiber mat according to the invention have a length LF smaller than or equal to 200 μm. And, in a second box C2, one could notice that 22% of the wood fibers present in this same given sample of a plant fiber mat according to the invention have a length LF smaller than or equal to 1,000 μm. One could deduce from these two values that 16.5% of the wood fibers present in this sample have a length LF comprised between 200 μm and 1,000 μm, the 5.5% of wood fibers whose length LF is smaller than or equal to 200 μm forming part of the 22% of wood fibers whose length LF is smaller than or equal to 1,000 μm.

Thus, the tests that the Inventors have been able to conduct on this sample show, when studying the values of the cumulative distribution CD, that at least 44% of the wood fibers forming a plant fiber mat 1 in accordance with the invention have a length of at most 2,000 μm. In addition, it should be noted that, as shown in FIG. 2, 85.5% of the wood fibers have a length LF of at most 5,000 μm.

By carrying out tests on other wood types having lignin and cellulose contents in accordance with the foregoing, and in particular on common beech wood, the Inventors have been able to notice that a plant fiber mat in accordance with the invention may comprise at least 60% of wood fibers whose length is smaller than or equal to 3,000 μm.

FIG. 2 also allows highlighting ranges of the values of the dimensions of wood fibers, herein their length, that are most represented within the plant fiber mat 1. More specifically, the increase in the cumulative distribution CD between a given first length of wood fibers LF, for example ≤2,000 μm, a given second length of wood fibers LF, for example ≤3,500 μm, and a given third length of wood fibers LF, for example ≤5,000 μm, allows highlighting that there are more wood fibers, herein Douglas fir wood, that have a length comprised between 2,000 μm and 3,500 μm, whereby they represent about 24% of the total mass of plant fibers present in the mat, than Douglas fir fibers that have a length comprised between 3,500 μm and 5,000 μm, whereby they represent about 17.5% of the total mass of plant fibers present in the mat.

FIG. 3 covers the same test as that one set out in FIG. 2, this time while taking into account the diameter of the wood fibers DF.

Each cumulative distribution value CD illustrates the percentage of wood fibers, within a given sample, that have a diameter smaller than a given dimension. The values combined in FIG. 3 successively illustrate that 2.5% of the wood fibers present in a given sample of a plant fiber mat according to the invention have a diameter DF smaller than or equal to 30 μm, that 22.5% of the wood fibers present in this sample have a diameter DF smaller than or equal to 40 μm, that 47.5% of the fibers present in a given sample of a plant fiber mat according to the invention have a diameter DF smaller than or equal to 50 μm, that 64.5% of the wood fibers present in this sample have a diameter DF smaller than or equal to 70 μm, and that 73.5% of the wood fibers present in this sample have a diameter DF smaller than or equal to 100 μm.

Thus, the tests that the Inventors have been able to conduct on this sample show, when studying the values of the cumulative distribution CD, that at least 73.5% of the wood fibers 2, herein Douglas fir wood fibers, have a diameter smaller than or equal to 100 μm and at least 64.5% of these wood fibers 2 have a diameter DF smaller than or equal to 70 μm.

Herein again, it should be noted that by carrying out tests on other wood types having lignite and cellulose contents in accordance with the foregoing, and in particular on common beech wood, the Inventors have been able to notice that a wood fiber mat in accordance with the invention may comprise at least 60% of fibers whose diameter DF is smaller than or equal to 70 μm and at least 50% of fibers whose diameter DF is comprised between 50 μm and 55 μm.

As mentioned before, the wood fiber mat 1 is formed of an entanglement of plant fibers, and more particularly wood fibers. As shown in FIG. 4, these wood fibers 2 are secured to one another by means of dry-bonding elements. More particularly, these bonding elements are formed by heat-bonding fibers 3.

The plant fiber mat 1 is obtained by means of a manufacturing facility in which the wood fibers 2 are mixed with the heat-bonding fibers 3 so as to obtain a heat-bonding fiber content that is lower than 10%, preferably comprised between 2% and 5%.

In one embodiment of the invention, the mixture of wood fibers 2 and heat-bonding fibers 3, obtained according to the contents that have just been mentioned, is blown into a manufacturing facility and then sucked against a conveyor in order to form a wood fiber carpet. This wood fiber carpet is then heated in an oven to form the plant fiber mat 1. The plant fiber mat may be cut into insulating panels of different sizes or rolled up and compressed for storage.

The heat-bonding fibers 3 are formed of a core 31 and a sheath 32. The core 31 forms a rigid portion of the heat-bonding fibers 3 participating in conferring a mechanical strength on the straw fiber mat 1, whereas the sheath 32 secures the plant fibers 2 to one another. To this end, the core 31 and the sheath 32 have different melting temperatures, and more specifically the sheath 32 has a lower melting temperature than the core 31.

Thus, during the passage of the wood fiber carpet in an oven to obtain a plant fiber mat in accordance with the invention, the temperature within the oven is such that the sheath 32 melts down so as to soak the adjacent wood fibers, the assembly solidifying by cooling at the outlet of the oven so as to secure these wood fibers to one another. It should be noted that the melting temperature of the core 31 is set so that, despite the passage of a wood fiber carpet consisting of the mixture of wood fibers and binder in the oven, the core 31 preserves its rigid property participating in ensuring a mechanical strength to the plant fiber mat 1 after the oven.

It should be understood that within the oven, the wood fibers 2 and the heat-bonding fibers 3 are heated so that the wood fibers 2 stick to each other. At least the passage in the oven, and where appropriate a subsequent compression and cutting before packaging, transforms the wood fiber carpet into a plant fiber mat in accordance with the invention.

The plant fiber mat has a thickness of at least 20 mm and preferably larger than 40 mm. This thickness is considered after passage of the wood fiber carpet in the oven.

In the shown embodiment, the sheath 32 of the heat-bonding fibers 3 is formed of polyethylene and the core 31 is also formed of polyethylene. It should be noted that in an alternative embodiment, the core 31 of the heat-bonding fibers may be formed of a polyester, and more specifically of polyethylene terephthalate. Polyethylene has the advantage of easily bonding to the plant fibers which makes it a good candidate for forming the sheath 32 of the heat-bonding fibers.

It should be noted that this is just an exemplary embodiment, the plant fiber mat 1 could be obtained by a different manufacturing facility, for example a manufacturing facility in which the wood fibers 2 and the bonding elements are mechanically deposited over a conveyor and then directed to an oven so as to form the plant fiber mat 1. Nonetheless, the heat-bonding fiber 3 content in the plant fiber mat 1 and the structure of said heat-bonding fibers 3 remain identical.

The heat-bonding fibers are characterized in particular by their fineness. This fineness is expressed in decitex, commonly defined as the mass in grams of ten thousand meters of this heat-bonding fiber 3. According to the invention, the heat-bonding fibers 3 have a fineness lower than or equal to 1.7 dtex, preferably lower than or equal to 1.5 dtex. Such a fineness of the heat-bonding fibers 3 allows for a better distribution of these heat-bonding fibers within the mat, between the wood fibers, which is more effective for sizing and fixing the position of the wood fibers relative to one another.

It should be understood that it is thus possible to ensure more easily that the wood fibers do not come into contact and do not form thermal bridges. The best distribution of the heat-bonding fibers, resulting from the fineness of these fibers as highlighted according to the invention, allows limiting the mass or volume ratio of heat-bonding elements in the overall mass or volume of the insulating product formed by the plant fiber mat.

Furthermore, the heat-bonding fibers 3 have a length, while taking into account the manufacturing tolerances, of about 6 mm, which, in complementarity with the aforementioned fineness, could allow for a better distribution of the heat-bonding fibers within the plant fiber mat 1. More particularly, it should be noted that this length of the heat-bonding fibers could be smaller than or equal to 6 mm.

The fineness of the heat-bonding fibers is particularly interesting herein insofar as it is complementary to the fineness of the wood fibers, mentioned by the fact that at least 60% of the plant fibers have a diameter smaller than 70 microns, which allows obtaining a good mixture of the two types of fibers present in the mat and a homogeneous distribution of the heat-bonding fibers between the wood fibers, which allows for a good attachment of the wood fibers and the even formation of air pockets allowing lowering the thermal conductivity value to the desired values for application in building insulation.

The different elements described as participating in the formation of the plant fiber mat 1 allow obtaining such a mat whose volumetric density is comprised between 20 kg·m³ and 80 kg·m³ and, as mentioned before, with a thickness of at least 20 mm. Such a plant fiber mat has a thermal conductivity lower than or equal to 37 mW/m/K at 10° C., allowing conferring optimum insulating properties on a building material.

The invention as it has just been described achieves the aim it has set by proposing a plant fiber mat whose thermal insulation performances are optimized by means of a composition and a distribution of dimensions of the particular plant fibers, namely wood fibers and for example products derived from silviculture, within the plant fiber mat.

1. A plant fiber mat comprising wood fibers derived from woody plants and secured to one another by means of heat-bonding fibers, the heat-bonding fibers having a decitex lower than or equal to 1.7 dtex.

2. The plant fiber mat according to claim 1, wherein the heat-bonding fibers have a decitex lower than or equal to 1.5 dtex.

3. The plant fiber mat according to claim 1, wherein the wood fibers are derived from resinous woody plants.

4. The plant fiber mat according to claim 1, comprising at least 50% of wood fibers derived from woody plants.

5. The plant fiber mat according to claim 1, comprising adjuvant fibers derived from agriculture.

6. The plant fiber mat according to claim 5, comprising at least 80% of wood fibers and at most 20% of adjuvant fibers.

7. The plant fiber mat according to claim 1, comprising at most 10% of heat-bonding fibers.

8. The plant fiber mat according to claim 7, comprising between 2% and 5% of heat-bonding fibers.

9. The plant fiber mat according to claim 1, comprising at least 95% of fibers and at most 5% of additives.

10. The plant fiber mat according to claim 9, wherein at least 95% of the fibers are wood fibers.

11. The plant fiber mat according to claim 1, wherein the wood fibers derived from woody plants have a cellulose content comprised between 30 and 60 kg·100 kg⁻¹ of dry matter and a lignin content comprised between 18 and 30 kg·100 kg⁻¹ of dry matter.

12. The plant fiber mat according to claim 11, wherein the wood fibers derived from woody plants have a cellulose content comprised between 41.2 and 56.4 kg·100 kg⁻¹ of dry matter and a lignin content comprised between 23.7 and 28.1 kg·100 kg⁻¹ of dry matter.

13. The plant fiber mat according to claim 1, wherein at least 70% of the wood fibers have a diameter smaller than or equal to 100 μm.

14. The plant fiber mat according to claim 13, wherein at least 60% of the wood fibers have a diameter smaller than 70 μm.

15. The plant fiber mat according to claim 1, wherein at least 60% of the wood fibers have a diameter comprised between 30 μm and 70 μm.

16. The plant fiber mat according to claim 1, wherein at least 85% of the wood fibers have a length smaller than or equal to 5,000 μm.

17. The plant fiber mat according to claim 1, characterized in that it wherein the plant fiber mat has a thickness larger than 20 mm.

18. The plant fiber mat according to claim 1, characterized in that it wherein the plant fiber mat has a volumetric density comprised between 20 kg·m⁻³ and 80 kg·m⁻³.

19. The plant fiber mat according to claim 1, wherein the heat-bonding fibers comprise at least polyethylene.

20. The plant fiber mat according to claim 1, wherein the plant fiber mat has a thermal conductivity lower than or equal to 37 mW/m/K at 10° C.
